(19) United States
(12) Patent Application Publication
(10) Pub. No.: US 2019/0062496 A1
(43) Pub. Date: Feb. 28, 2019

(54) METHOD FOR THE MANUFACTURE OF FLUORINATED POLYMERS AND POLYMERS OBTAINABLE THEREFROM

(71) Applicant: SOLVAY SPECIALTY POLYMERS ITALY S.P.A., Bollate (Milano) (IT)

(72) Inventors: Claudio Adolfo Pietro TONELLI, Paderno d'Adda (IT); Ivan Diego WLASSICS, Garessio (IT); Stefano MILLEFANTI, Tradate (IT); Letanzio BRAGANTE, Due Carrare (IT); Solange BARBIERI, Baranzate (IT); Giuseppe MARCHIONNI, Milano (IT)

(73) Assignee: Solvay Specialty Polymers Italy S.p.A., Bollate (Milano) (IT)

(21) Appl. No.: 16/079,090

(22) PCT Filed: Feb. 20, 2017
(86) PCT No.: PCT/EP2017/053794

§ 371 Date: Aug. 22, 2018

(30) Foreign Application Priority Data
Feb. 23, 2016 (EP) 16156856.3

(51) Int. Cl. C08G 65/00; C08G 65/334

(52) U.S. Cl. CPC C08G 65/007; C08G 2650/48; C08G 65/3346

(57) ABSTRACT

A method for the manufacture of fluorinated polymers and polymers obtainable therefrom are herein disclosed. The method envisages the reaction of a) first reagent [reagent (R1)] which is an alcohol selected from a (per)fluoropolyether (PFPE) alcohol a fluoroalkylene diol and a mixture thereof; b) a second reagent [reagent (R2)] which is a sulfonic ester of a PFPE, a sulfonic diester of a fluoroalkylene diol or a mixture thereof and, optionally, c) a third reagent which is a mono-functional (per)haloalkyl alcohol or a sulfonic ester thereof in the presence of an organic or inorganic base. At least reagent (R1) is a PFPE alcohol (A) or at least reagent (R2) is a PFPE sulfonic ester (B) and the overall equivalents of alcohols are the same as the overall equivalents of sulfonic esters. The method allows to obtain in a convenient way non-functional polymers comprising at least a PFPE segment and having high molecular weight.

### CROSS REFERENCE TO PREVIOUS APPLICATIONS

This application claims priority from European patent application n. 16156856.3, filed on Feb. 23, 2016; the whole content of this application is herein incorporated by reference.

### TECHNICAL FIELD

The present invention relates to a method for the manufacture of fluorinated polymers and to polymers obtainable therefrom. In particular, it relates to a method for the obtainment of non-functional fluorinated polymers comprising one or more (per)fluoropolyether segments and, optionally, one or more (per)fluoroalkyl segments.

### BACKGROUND ART

(Per)fluoropolyethers (PFPEs) are fluorinated polymers comprising a fully or partially fluorinated polyoxyalkylene chain (PFPE chain) that contains recurring units having at least one catenary ether bond and at least one fluorocarbon moiety. PFPEs can be non-functional (or neutral) and functional; the former comprise a PFPE chain whose ends bear (per)haloalkyl groups, while the latter comprise a PFPE chain wherein at least one end comprises a functional group. The most widespreadly known PFPEs can be obtained by homopolymerization of hexafluoropropylene oxide (HFPO) or 2,2,3,3-tetrafluorooxetane and by photooxidation of tetrafluoroethylene (TFE) and/or hexafluoropropylene (HFP).

PFPEs are in the form of oils under standard temperature and pressure conditions and at relatively high or low temperature; thanks to their stability, inertness, low volatility and outstanding rheological and tribological properties, they are useful in a variety of applications, mainly lubricant applications, wherein harsh conditions are reached (e.g. high temperature, friction, etc.). Neutral PFPEs are typically used as base oils, while functional PFPEs are typically used as additives in polymer formulations.

One of the main problems in the synthesis of neutral PFPEs lies in the difficulty of obtaining PFPEs with high molecular weight. Typically, conventional methods allow obtaining neutral PFPEs having an average number molecular weight (Mₙ) ranging from 400 and 5,000. PFPE with (Mₙ) ranging from 3,500 5,000 are usually isolated from mixtures comprising PFPEs with lower (Mₙ).

Among functional PFPEs, PFPE alcohols, in particular those terminating with one or two —CH₂OH groups, can be used as valuable intermediates for the manufacture of other PFPEs. Indeed, the hydroxy group can react as a nucleophile or can be transformed into a leaving group that undergoes nucleophilic displacement. One of such leaving groups is, for example, a sulfonic ester group, as disclosed, for example, in the following articles:

TONELLI, Claudio, et al. Linear perfluoropolyethers difunctional oligomers: chemistry, properties and applications. Journal of Fluorine Chemistry. 1999, vol.95, p.51-70; and TONELLI, Claudio, et al. Perfluoropolyether functional oligomers: unusual reactivity in organic chemistry. Journal of Fluorine Chemistry. December 2002, vol.118, no.1-2, p.107-121.

SCICCHITANO, Massimo, et al. Synthesis and characterization of low-viscosity fluoropolyether-based segmented oligomers. Die Angewandte Makromoleculare Chemie. 1995, vol. 231, p.47 60, disclose, inter alia, the reaction of Fomblin® Z DOL TX PFPE with tosyl chloride, to provide the corresponding sulfonic diester.

SCICCHITANO, Massimo, et al. Cyclic acetals of fluorinated polyether alcohols. Journal of Fluorine Chemistry. 1999, vol.95, p.97-103, disclose the reaction of Fomblin® Z DOL PFPE with dihalomethanes to provide a dihalogenated derivative which may react with Fomblin® Z DOL PFPE to provide derivatives comprising PFPE segments and hydrogenated segments of formula —CH₂OCH₂OCH₂—. However, such segments are not stable and undergo hydrolysis under acid conditions.

U.S. Pat. No. 6,096,694 (FUJJ ELECTRIC. CO., LTD.) 1 Aug. 2000 teaches to react Fomblin® Z DOL PFPE with triflic anhydride to provide Fomblin® Z DOL PFPE triflate, which is then reacted with pyrimidyl pyperazine or with diethylamine to provide corresponding PFPEs having at least one tertiary amino group at at least one end of the polymer chain. Such PFPEs are used to manufacture a lubricant layer to be placed on top of a carbon protective layer of a magnetic recording medium.

WO 2009/043928 (SOLVAY SOLEXIS S.P.A.) 9 Apr. 2009 relates to a process for the manufacture of a PFPE polyol derivative which comprises the reaction of a PFPE alcohol with an activated protected triol. The activated protected triol can be a sulfonic monoester thereof obtained by reaction of a triol having two protected hydroxyl functions with a sulphonyl halide.

WO 2010/115855 A1 (SOLVAY SOLEXIS S.P.A.) 14 Oct. 2010 relates to a process for the manufacture of a PFPE functional derivative comprising at least one triazole group, said process comprising the reaction of a PFPE alcohol with an activating agent; the activated agent can be a sulphonyl halide.

EP 0501533 A (DAIKIN INDUSTRIES, LIMITED) 2 Sep. 1992 discloses block copolymers of the type A-B or A-B-A, which may be prepared by polymerizing at least one fluorine-containing olefin in the presence of an iodinated compound comprising the block A and a iodine atom at at least one end, and a radical-generating source. Such copolymers thus comprise at least one iodine atom that can optionally be replaced with other atoms or atomic groups. The copolymers are said to have good lubrication and protective properties and to be suitable for use as greases, due to the concomitant presence of block A having good lubricity like an oil and block B acting as a thickening agent.

Polymers comprising both (per)fluoropolyoxyalkylene segments and fully hydrogenated segments are also known and can be used instead of PFPEs in applications in which PFPEs would be outperforming and/or too expensive, for example in the field of lubrication.

For example, EP 2089443 B (SOLVAY SOLEXIS S.P.A.) 19 Aug. 2009 discloses non-functional block copolymers comprising (per)fluoropolyether blocks and blocks deriving from one or more homopolymerizable olefins. Such block copolymers can be manufactured by means of a process comprising the reaction of a peroxidic PFPE with one or more homopolymerizable olefins by radical route, thermal treatment and neutralization.

WO 2010/057691 A (SOLVAY SOLEXIS SPA) 27 May 2010 discloses, inter alia, bifunctional hydrofluoroalcohols comprising a plurality of (per)fluoropolyether (PFPE) segments joined together by —O—Rₕ—O— segments, wherein Rₕ is a hydrocarbon-based chain. For instance, Example 3 discloses a compound having formula:

HOCH₂CH₂CH₂CH₂—OCF₂—R_{f}—CF₂O—CH₂CH₂CH₂CH₂O—(CF₂—R_{f}—CF₂O—CH₂CH₂CH₂CH₂O)ₙH,

while example 8 discloses a compound of formula:

HOCH₂CH₂CH₂—OCF₂—R_{f}—CF₂O—CH₂CH₂CH₂O(CF₂—R_{f}—CF₂O—CH₂CH₂CH₂O)ₙH

wherein R_{f} is a PFPE chain.

Such compounds are obtained by reaction of a difunctional alkylating compound with a carbonyl derivative of a PFPE in the presence of a source of fluoride anion, followed by hydrolysis of the resulting product.

WO 2016/083280 A1 (SOLVAY SPECIALTY POLYMERS ITALY S.P.A.)

2 Jun. 2016 discloses mixtures of mono-, bi- and non-functional fluorinated polymers and derivatives thereof. Such mixtures are obtained by reaction of a PFPE diol with a PFPE sulfonic esters having different average functionality, with the proviso that the overall average functionality of the PFPE diol and PFPE sulfonic ester is lower than 1.98. The non-functional polymers contained in the mixtures comprise a plurality of (per)fluoropolyether segments joined together by hydrogenated (poly)ether segments, with the proviso that the hydrogenated (poly)ether segments are not segments of formula —CH₂OCH₂OCH₂—. These non-functional polymers can be present in the mixtures in variable amounts, typically ranging from about 1 to about 25% wt with respect to the weight of the mixture, said amounts depending on the overall average functionality of the PFPE diol and PFPE ester. This application also discloses reacting the mixture with a halogenated monofunctional alkyl alcohol in order to increase the amount of non-functional PFPEs. However, non-functional PFPEs can be isolated from the mixtures only by fractionation or high vacuum distillation. Furthermore, this patent application does not disclose or suggest mixtures obtained by reaction of a PFPE diol with a sulfonic diester of a (per)fluoroalkylene diol or by reaction of a sufonic diester of a PFPE diol and a (per)fluoroalkylene diol. The need is thus still felt to provide a method for manufacturing highly pure non-functional fluorinated polymers comprising at least one PFPE segment and hydrogenated segments, said polymers having a wide range of molecular weights, in particular high molecular weights, said method being conveniently implementable on an industrial scale.

### SUMMARY OF INVENTION

The Applicant has found out that non-functional fluorinated polymers comprising at least one PFPE segment [“polymers (P)”] can be conveniently manufactured by means of a method [method (M)] comprising the reaction of:

a) a first reagent [reagent (R1), which is an alcohol selected from a PFPE alcohol having an average functionality (F_{A}) ranging from 1.2 to 2 [“PFPE alcohol (A)”], a fluoroalkylene diol [alcohol (Aa)] and a mixture thereof;

b) a second reagent [reagent (R2)], which is a sulfonic ester selected from a sulfonic ester of a PFPE alcohol having an average functionality (F_{B}) ranging from 1.2 to 2 [herein after “PFPE sulfonic ester (B)”], a sulfonic diester of a fluoroalkylene diol [sulfonic ester (Bb)] and a mixture thereof and

c) a third reagent [reagent (R3)], which is a mono-functional halogenated alcohol [alcohol (C)] or a sulfonic ester thereof [sulfonic ester (Cc)], reagent (R3) being optional when (F_{A}) and/or (F_{B}) is lower than 1.98, in the presence of an organic or inorganic base,

characterised in that:

(i) at least reagent (R1) is a PFPE alcohol (A) or at least reagent (R2) is a PFPE sulfonic ester (B) and in that

(ii) the overall equivalents of alcohols are the same as the overall equivalents of sulfonic esters.

Method (M) is particularly advantageous due to the fact that polymers (P) can be obtained with high yield and purity without the need of fractionation or high vacuum distillation.

Furthermore, method (M) allows obtaining polymers (P) with different structures according to the selected reagents, advantageously polymers (P) with high molecular weight, as explained in detail below.

### Definitions, Symbols and Abbreviations

For the purposes of the present application:
the term “(per)fluoropolyether” stands for a fully or partially fluorinated polyether;
the acronym “PFPE(s)” stands for “(per)fluoropolyether(s)”;
the term “(poly)ether” stands for ether or polyether;
the term “(per)haloalkyl” denotes a straight or branched alkyl group wherein one or more hydrogen atoms have been replaced with halogen atoms;
unless otherwise indicated, the term “halogen” includes fluorine, chlorine, bromine or iodine and “halogenated” means containing one or more fluorine, chlorine, bromine and/or iodine atoms;
the expression “hydrogenated (poly)ether segment” denotes a (poly)ether segment comprising only C, H and O atoms;
the use of parentheses “( . . . )” before and after symbols, numbers or letters identifying formulae or parts of formulae like, for example, method (M), polymer (P), etc . . . , has the mere purpose of better distinguishing that symbol, number or letter from the rest of the text; thus, said parentheses could also be omitted;
the expression “non-functional” or “neutral” polymer means that the polymer terminates with a (per)haloalkyl group;
the expression “as defined above” is intended to comprise all generic and specific or preferred definitions or embodiments referred to by that expression in preceding parts of the description;
an “aryl group” is a hydrocarbon monovalent group consisting of one core composed of one benzenic ring or of a plurality of benzenic rings fused together by sharing two or more neighboring ring carbon atoms, and of one end. Non limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group.

### The PFPE Alcohol (A)

For the purpose of the present application, a PFPE alcohol (A) is an alcohol comprising a fully or partially fluorinated polyoxyalkylene chain [chain (R_{f})] having two ends, wherein at least one end bears a hydrocarbon group containing one hydroxy group, said group being partially fluorinated and optionally containing one or more ethereal oxygen atoms, and the other end bears either a hydrocarbon group containing one hydroxy group as defined herein before or a (per)haloalkyl group. For the sake of clarity, when both ends bear a hydrocarbon group containing one hydroxy group as defined herein before, groups can be equal to or different from one another.

Typically, PFPE alcohols (A) are available as mixtures of mono- and di-functional alcohols, and, optionally, non-functional PFPEs in a molar amount lower than 0.04%, said mixtures being defined by an average functionality (F).

The average functionality (F_{A}) of PFPE alcohol (A) is the average number of hydroxy groups per alcohol molecule; PFPE alcohols (A) suitable for carrying out method (M) can have a functionality (FA) ranging from 1.2 to 2. Average functionality (F_{A}) can be calculated according to methods known in the art, for example as disclosed in EP 1810987 A (SOLVAY SOLEXIS S.P.A.) 25 Jul. 2007.

Typically, chain (R_{f}) has a number average molecular weight ranging from 400 to 5,000 and comprises recurring units (R°) selected from:

(i) —CFXO—, wherein X is F or CF₃,

(ii) —CFXCFXO—, wherein X, equal or different at each occurrence, is F or CF₃, with the proviso that at least one of X is —F,

(iii) —CF₂CF₂CW₂O—, wherein each of W, equal or different from each other, are F, Cl, H,

(iv) —CF₂CF₂CF₂CF₂O—,

(v) —(CF₂)ⱼ—CFZ*—O— wherein j is an integer from 0 to 3 and Z* is a group of general formula —OR_{f}*T, wherein R_{f}* is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

Preferably, chain (R_{f}) complies with the following formula:

—(CFX¹O)_{g1}(OFX²CFX³O)_{g2}(CF₂CF₂CF₂O)_{g3}(CF₂CF₂CF₂CF₂O)_{g4}— (R_{f}-I)

wherein:
X¹ is independently selected from —F and —CF₃,
X², X³, equal or different from each other and at each occurrence, are independently —F, —CF₃, with the proviso that at least one of X is —F;
g1, g2 g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—(CF₂CF₂O)ₐ₁(CF₂O)ₐ₂— (R_{f}-IIA)

wherein:
a1 and a2 are independently integers 0 such that the number average molecular weight is between 400 and 5,000; both a1 and a2 are preferably different from zero, with the ratio a1/a2 being preferably comprised between 0.1 and 10;

—(CF₂CF₂O)_{b1}(CF₂O)_{b2}(CF(CF₃)O)_{b3}(CF₂CF(CF₃)O)_{b4}— (R_{f}-IIB)

wherein:

b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being ≥1;

—(CF₂CF₂O)_{c1}(CF₂O)_{c2}(CF₂(CF₂)_{cw}CF₂O)_{c3}— (R_{f}-IIC)

wherein:

cw=1 or 2;

c1, c2, and c3 are independently integers ≥0 chosen so that the number average molecular weight is between 400 and 10,000, preferably between 400 and 5,000; preferably c1, c2 and c3 are all >0, with the ratio c3/(c1+c2) being generally lower than 0.2;

—(CF₂CF(CF₃)O)_{d}— (R_{f}-IID)

wherein:

d is an integer >0 such that the number average molecular weight is between 400 and 5,000;

—(CF₂CF₂C(Hal)₂O)ₑ₁—(CF₂CF₂CH₂O)ₑ₂—(CF₂CF₂CH(Hal)O)ₑ₃— (R_{f}-IIE)

wherein:
Hal, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—(CF₂CF₂O)ₐ₁(CF₂O)ₐ₂— (R_{f}-III)

wherein:
a1, and a2 are integers >0 such that the number average molecular weight is between 400 and 4,000, with the ratio a2/a1 being generally comprised between 0.2 and 5.

Typically, a PFPE alcohol (A) complies with formula (A-1) here below:

Z—O—R_{f}—Z′ (A-1)

wherein (R_{f}) is a fluoropolyoxyalkylene chain as defined above and Z and Z′, equal to or different from one another, represent a hydrocarbon group containing one hydroxy group, said hydrocarbon group being partially fluorinated and optionally containing one or more ethereal oxygen atoms, or a C₁-C₃ haloalkyl group, typically selected from —CF₃, —CF₂Cl, —CF₂CF₂Cl, —C₃F₆Cl, —CF₂Br, —CF₂CF₃ and —CF₂H, —CF₂CF₂H.

Preferred groups Z and Z′ comply with formula:

—CFX° CH₂(OCH₂CHY)ₙOH (Z-1)

wherein:
X° is F— or CF₃—, preferably F,
Y is hydrogen or methyl and
n is 0 or an integer equal to or higher than 1, preferably ranging from 1 to 10.

Preferred PFPE alcohols (A-1) are those wherein (R_{f}) complies with formula (R_{f}-III) as defined above, X° is F—, Y is H and n is 0 or is an integer ranging from 1 to 10; most preferably, n is 0 or 1.

Preferred PFPE alcohols (A-1) wherein n is 0 can be obtained according to known methods, for example as disclosed in EP 1614703 A (SOLVAY SOLEXIS S.P.A.) 11 Jan. 2006.

Preferred PFPE alcohols (A-1) wherein n is equal to or higher than 1 can be obtained from a PFPE alcohol (A-1) wherein n is 0 by reaction with ethylene oxide or propylene oxide in the presence of a base. In particular, PFPE alcohols (A-1) comprising groups Z and Z′ complying with formula (Z-1) in which n ranges from 1 to 10 can be conveniently manufactured with the method disclosed in WO 2014/090649 A (SOLVAY SPECIALTY POLYMERS ITALY) 19 Jun. 2014.

### Alcohol (Aa)

For the purpose of the present application, alcohol (Aa) is a fluoroalkylene diol, namely a bifunctional alcohol comprising a straight or branched fully or partially fluorinated alkylene chain comprising two hydroxy groups.

Typically, alcohol (Aa) comprises two hydroxymethyl (—CH₂OH) or two hydroxyethyl (—CH₂CH₂OH) groups.

Preferably, alcohol (Aa) complies with formula (Aa-1) here below:

HO—(CH₂)_{n*}—(R_{f1a})—(CH₂)_{n*}—OH (Aa-1)

in which:
(R_{f1a}) is a straight or branched fully or partially fluorinated alkylene chain and
n* is 1 or 2.

Preferably, chain (R_{f1a}) is a straight or branched C₂-C₂₀ fully or partially fluorinated alkylene chain. More preferably, chain (R_{f1a}) is fully fluorinated, i.e. is a perfluorinated chain and is a straight perfluoroalkylene chain.

Convenient examples of alcohols (Aa-1) are:
8H,8H-dodecafluoro-1,8-octanediol of formula:

HO—CH₂(CF₂)₆CH₂—OH

and
1H, 1H, 10H, 10H-hexadecafluoro-1,10-decanediol of formula:

HO—CH₂(CF₂)₈CH₂—OH.

### The PFPE Sulfonic Ester (B)

For the purpose of the present application, a PFPE sulfonic ester (B) is a sulfonic ester of a PFPE alcohol (A) as defined above.

Typically, sulfonic esters are (halo)alkyl sulfonic esters, fluoroalkyl sulfonic esters, or aryl sulfonic esters, preferably phenyl sulfonic esters, wherein the aryl moiety optionally bears one or more (halo)alkyl substituents, preferably (fluoro)alkyl substituents, and/or one or more nitro groups.

Preferred sulfonic esters are trifluoromethanesulfonic (triflate), nonafluorobutanesulfonic (nonaflate) and p-toluenesulfonic (tosylate) esters.

Typically, a PFPE sulfonic ester (B) complies with formula (B-1) here below:

E-O-R_{f}-E′ (B-1)

wherein (R_{f}) is a fluoropolyoxyalkylene chain as defined above and E and E′, equal to or different from one another, represent a hydrocarbon group, bearing one sulfonic ester group, said hydrocarbon group being partially fluorinated and optionally containing one or more ethereal oxygen atoms, or a C₁-C₃ haloalkyl group, typically selected from —CF₃, —CF₂Cl, —CF₂CF₂Cl, —C₃F₆Cl, —CF₂Br, —CF₂CF₃ and —CF₂H, —CF₂CF₂H.

Preferred group E and E′ comply with formula (E-1) below:

—CFX° CH₂(OCH₂CHY)ₙE* (E-1)

wherein:
X° is F— or CF₃—, preferably F,
Y is hydrogen or methyl, preferably methyl,
n is 0 or is an integer equal to or higher than 1, preferably ranging from 1 to 10, and
E* is selected from a mesylate, nonaflate or tosylate group. Most preferably n is 0 or 1.

Preferred PFPE sulfonic esters of formula (B-1) are those wherein (R_{f}) complies with formula (R_{f}-III) and groups E and E′ comply with formula (E-1), wherein X° is F—, Y is H and n is 0 or is an integer ranging from 1 to 10; most preferably, n is 0 or 1.

PFPE sulfonic esters (B) can be obtained from PFPE alcohols (A) according to methods known in the art; for example, PFPE sulfonic esters (B) comprising perfluoroalkanesulfonate end groups can be prepared following the teaching of TONELLI, Claudio, et al. Linear perfluoropolyethers difunctional oligomers: chemistry, properties and applications. Journal of Fluorine Chemistry. 1999, vol.95, p.51-70.

PFPE sulfonic esters (B) suitable for carrying out method (M) can have a functionality (FB) ranging from 1.2 to 2, wherein (FB) is the average number of sulfonic ester groups per ester molecule. Average functionality (FB) can be calculated according to methods known in the art, for example by appropriate modification of the method disclosed in EP 1810987 A (SOLVAY SOLEXIS S.P.A.) 25 Jul. 2007 . Typically, (FB) is the same as the functionality of the precursor PFPE alcohol (A).

When a PFPE alcohol (A) is used as reagent (R1) and a PFPE sulfonic ester (B) is used as reagent (R2) in method (M), the PFPE alcohol (A) used as precursor of the PFPE ester (B) can be equal to or different from the PFPE alcohol (A) used as reagent; the difference may consist in one or more of the structure of chain (R_{f}) and molecular weight, groups Z and Z′ and functionality.

In one preferred embodiment, the PFPE alcohol (A) used as starting material for PFPE sulfonic ester (B) is the same as PFPE alcohol (A) used as reagent (R1) in method (M).

In another preferred embodiment, the PFPE alcohol (A) used as starting material for PFPE sulfonic ester (B) differs from alcohol PFPE alcohol (A) used as reagent in method (M) only in its average functionality.

### The Sulfonic Ester (Bb)

For the purpose of the present application, a sulfonic ester (Bb) is a sulfonic ester of an alcohol (Aa) as defined above.

Typically, sulfonic esters are (halo)alkyl sulfonic esters, preferably fluoroalkyl sulfonic esters, or aryl sulfonic esters, preferably phenyl sulfonic esters, wherein the aryl moiety optionally bears one or more (halo)alkyl substituents, preferably (fluoro)alkyl substituents, and/or one or more nitro groups. Typically, a sulfonic ester (Bb) comprises two sulfonylmethyl groups.

A sulfonic ester (Bb) is typically an ester of formula (Bb-1) here below:

R—SO₂O—(CH₂)_{n*}—(R_{f1a})—(CH₂)_{n*}—OSO₂R (Bb-1)

wherein:
(R_{f1a}) and n* are as defined above; and
R is selected from: (halo)alkyl, preferably fluoroalkyl; aryl, preferably phenyl, wherein the aryl or phenyl moiety optionally bears one or more (halo)alkyl substituents, preferably (fluoro)alkyl substituents, and/or one or more nitro groups.

Advantageously, R is selected from trifluoromethyl, nonafluorobutanesulfonyl and p-toluenesulfonyl.

Sulfonic esters (Bb) can be prepared according to methods known in the art from the corresponding alcohols (Aa) as defined above.

Preferred examples of sulfonic esters (Bb-1) are those obtained from -8H,8H-dodecafluoro-1,8-octanediol of formula:

HO—CH₂(CF₂)₆CH₂—OH

and
1H, 1H, 10H, 10H-hexadecafluoro-1,10-decanediol of formula:

HO—CH₂(CF₂)₈CH₂—OH.

### The Monofunctional Halogenated Alcohol (C)

For the purpose of the present application, the expression “monofunctional halogenated alcohol (C)” denotes a straight or branched fully or partially halogenated, preferably fluorinated, alkyl chain comprising one hydroxy group, said chain optionally comprising one or more ethereal oxygen atoms.

Preferably, alcohol (C) complies with formula (C-1) here below:

R_{f2}—OH (C-1)

in which (R_{f2}) is a straight or branched fully or partially halogenated, preferably fluorinated, alkyl chain, preferably a straight C2-C20 fully or partially halogenated, preferably fluorinated, alkyl chain, said chain optionally comprising one or more ethereal oxygen atoms.

Preferred alcohols (C-1) are selected from:
CF₃(CF₂)_{a′}CH₂OH, wherein a′=0-3;
(CF₃)₂CHOH;
CF₃OCF₂CF₂CH₂OH and
(CF₃)C—OH.

Further examples of alcohols (C-1) are monofunctional PFPE alcohols of formula (A-1) in which:
(R_{f}) complies with formula (R_{f}-III) as defined above and
one of Z and Z′ is CFX° CH₂OH and the other one is a C₁-C₃-haloalkyl group.

A convenient example of alcohol (C-1) is trifluoroethanol.

### The Sulfonic Ester (Cc)

For the purpose of the present application, the expression “sulfonic ester (Cc)” denotes a sulfonic ester of a monofunctional halogenated alcohol (C) as defined above.

Typically, sulfonic esters are (halo)alkyl sulfonic esters, preferably fluoroalkyl sulfonic esters, or aryl sulfonic esters, preferably phenyl sulfonic esters, wherein the aryl moiety optionally bears one or more (halo)alkyl substituents, preferably (fluoro)alkyl substituents, and/or one or more nitro groups.

Typically, sulfonic esters (Cc) comply with formula (Cc-1) here below:

R_{f2}—OSO₂R (Cc-1)

in which (R_{f2}) and R are as defined above.

Preferred sulfonic esters (Cc-1) are those selected from:
CF₃(CF₂)_{a′}CH₂OSO₂R, wherein a′=0-3;
(CF₃)₂CHOSO₂R
CF₃OCF₂CF₂CH₂OR and
(CF₃)C—OSO₂R.

in which R is as defined above.

Further examples of alcohols (C-1) are sulfonic esters of monofunctional

PFPE alcohols of formula (A-1) in which:
(R_{f}) complies with formula (R_{f}-III) as defined above and
one of Z and Z′ is —CFXCH₂OH and the other one is a C₁-C₃-haloalkyl group.

Sulfonic esters (Cc) can be obtained by sulfonylation reaction of the corresponding alcohols (C) according to methods known in the art.

Convenient examples of sulfonic esters (Cc) are triflate, nonaflate and tosylate esters of alcohols (C).

A convenient example of sulfonic ester (Cc) is CF₃CH₂OSO₂(CF₂)₃CF_{3.}

### Detailed Description of Method (M)

As stated above, the method of the invention comprises the reaction of:

a) a first reagent [reagent (R1)] which is an alcohol selected from a PFPE alcohol having an average functionality (F_{A}) ranging from 1.2 to 2 [“PFPE alcohol (A)”], a fluoroalkylene diol [alcohol (Aa)] and a mixture thereof;

b) a second reagent [reagent (R2)] which is a sulfonic ester selected from sulfonic ester of a PFPE alcohol having an average functionality (F_{B}) ranging from 1.2 to 2 [herein after “PFPE sulfonic ester (B)”], a sulfonic diester of a fluoroalkylene diol [sulfonic ester (Bb)] and a mixture thereof

c) a third reagent [reagent (R3)] which is a mono-functional halogenated alcohol [alcohol (C)] or a sulfonic ester thereof [sulfonic ester (Cc)], reagent (R3) being optional when (F_{A}) and/or (F_{B}) is lower than 1.98, in the presence of an organic or inorganic base,

characterised in that:

(i) at least reagent (R1) is a PFPE alcohol (A) or at least reagent (R2) is a PFPE sulfonic ester (B) and in that:

(iia) when reagent (R3) is not used, the overall equivalents of alcohols are the same as the overall equivalents of sulfonic esters;

(iib) when reagent (R3) is used, the overall equivalents of alcohols are the same as the overall equivalents of sulfonic esters or reagent (R3) can be used in excess with respect to the amount required to comply with this proviso.

For the sake of clarity, the expression “at least reagent (R1) is a PFPE alcohol (A) or at least reagent (R2) is a PFPE sulfonic ester (B)” means that:
if reagent (R1) is an alcohol (Aa), reagent (R2) is a PFPE sulfonic ester (B) or a mixture of a PFPE sulfonic ester (B) with a sulfonic ester (Bb);
if reagent (R2) is an ester (Bb), reagent (R1) is a PFPE alcohol (A) or a mixture of a PFPE alcohol (A) with an alcohol (Aa).

The expression “the overall equivalents of alcohols are the same as the overall equivalents of sulfonic esters” means that the ratio between the overall equivalents alcohols and the overall equivalents of sulfonic esters is substantially equal to 1. Typically, this ratio ranges between 0.99 to 1.01. A person skilled in the art will be able to comply with this proviso by selecting the functionality and the amount of the reagents. For the avoidance of doubt, when reagent (R3) is not used, the expression “overall equivalents”as referred to alcohol and sulfonic esters is referred to the reaction between the alcohol groups in (R1) and the ester groups in (R2) to form ether bonds. When reagent (R3) is used, the expression “overall equivalents”as referred to alcohols and sulfonic esters is referred to the reaction between the alcohol groups in (R1), the ester groups in (R2) and any alcohol and/or ester groups in (R3), to form ether bonds, irrespective of whether the reaction is carried out in one or more steps, namely two steps, as described further below. For example, when a PFPE alcohol (A) is used as reagent (R1) and a PFPE sulfonic ester (B) is used as reagent (R2) and the equivalents of PFPE alcohol (A) are higher than those of PFPE sulfonic ester (B), then a sulfonic ester (Cc) will be used as reagent (R3) in such an amount to satisfy this condition:

equivalents sulfonic ester (Cc)≥equivalents PFPE alcohol (A)−equivalents PFPE sulfonic ester (B),

irrespective of whether the reaction between the PFPE alcohol (A), the PFPE sulfonic ester (B) and the sulfonic ester (Cc) is carried out in one step or more steps.

In one convenient embodiment, reagent (R1) is a PFPE alcohol (A) and reagent (R2) is a PFPE sulfonic ester (B).

In another convenient embodiment, (R1) is a PFPE alcohol (A) and reagent (R2) is a sulfonic ester (Bb).

In a still further convenient embodiment, reagent (R1) is an alcohol (Aa) and reagent (R2) is a PFPE sulfonic ester (B).

Even if an alcohol (C) or sulfonic ester (Cc) [reagent (R3)] is optional when (F_{A}) and/or (F_{B}) is lower than 1.98 (i.e. it is necessary when both (F_{A}) and (F_{B}) are equal to or higher than 1.98), it is preferred to always use reagent (R3), in order to better control the polymer chain growth and, thus, the molecular weight, and to increase the kinetic reaction. The amount of alcohol (C) or sulfonic ester (Cc) can be equal to or higher than the amount necessary in order to comply with the proviso that the overall equivalents alcohols are the same as the overall equivalents of sulfonic esters. In particular, when method (M) is carried out in two steps as explained below, an excess of alcohol (C) or sulfonic ester (Cc), typically a 10% excess that the amount necessary to comply with the proviso can be used. Indeed, the use of such higher amount ensures that no free hydroxy or sulfonic end groups remain in the resulting polymer. Any excess of alcohol (C) or sulfonic ester (Cc) can be removed according to purification techniques known in the art.

Preferably, for the purpose of method (M), at least one of (F_{A}) or (F_{B}) is higher than 1.80, preferably higher than 1.95, more preferably higher than 1.98. Preferably, when both a PFPE alcohol (A) and a PFPE sulfonic ester (B) are used, both (F_{A}) and (F_{B}) are higher than 1.80, preferably higher than 1.95, more preferably higher than 1.98. Indeed, the higher the average functionality(ies), the narrower the average number molecular weight (Mₙ) of polymer (P).

Preferred Embodiment (M-1)

In one preferred embodiment [herein after “method (M-1)], reagent (R1) is a PFPE alcohol (A), reagent (R2) is a PFPE sulfonic ester (B) and reagent (R3) is an alcohol (C) or a sulfonic ester (Cc). The equivalents of PFPE alcohol (A) can be higher or lower than those of PFPE sulfonic ester (B); in the former case, a sulfonic ester (Cc) will be used, while in the latter case, an alcohol (C) will be used. In the former case, the resulting polymer (P) will comprise a plurality PFPE segments, wherein the outermost fluorinated segments derive from PFPE alcohol (A), said outermost segments having non-functional ends deriving from sulfonic ester (Cc). In the latter case, the resulting polymer (P) will comprise a plurality of PFPE segments, wherein the outermost fluorinated segments derive from PFPE sulfonic ester (B), said outermost segments having non-functional ends deriving from alcohol (C). It will be understood that, if the PFPE sulfonic ester (B) is prepared from the same PFPE alcohol (A), no distinction can be made between the outermost segments and the rest of the segments.

In general, the higher the ratio PFPE alcohol (A)/PFPE sulfonic ester (B) or PFPE sulfonic ester (B)/PFPE alcohol (A), the lower the length and, accordingly, average molecular weight, of the resulting polymer.

Preferred Embodiment (M-2)

In another preferred embodiment [herein after “method (M-2)], reagent (R1) is a PFPE alcohol (A), reagent (R2) is a sulfonic ester (Bb) and reagent (R3) is an alcohol (C) or a sulfonic ester (Cc). The equivalents of PFPE alcohol (A) can be higher or lower than those of sulfonic ester (Bb); in the former case, the resulting polymer (P) will comprise outermost fluorinated segments deriving from PFPE alcohol (A), said outermost segments having non-functional ends deriving from sulfonic ester (Cc), while in the latter case the resulting polymer (P) will comprise outermost fluorinated segments deriving from sulfonic ester (Bb), said outermost segments having non-functional ends deriving from alcohol (C).

Preferred Embodiment (M-3)

In another preferred embodiment [herein after “method (M-3)], a reagent (R1) is an alcohol (Aa), reagent (R2) is a PFPE sulfonic ester (B) and reagent (R3) is an alcohol (C) or a sulfonic ester (Cc). The equivalent of alcohol (Aa) can be higher or lower than those of PFPE sulfonic ester (B); in the former case the resulting polymer (P) will comprise outermost fluorinated segments deriving from alcohol (Aa), said outermost segments having non-functional ends deriving from sulfonic ester (Cc), while in the latter case the resulting polymer (P) will comprise outermost fluorinated segments deriving from PFPE sulfonic ester (B), said outermost segments having non-functional ends deriving from alcohol (C).

Preferred embodiments (M-1) (M-3), which envisage the use of an alcohol (C) or sulfonic ester (Cc), can be carried out in one or more steps.

When the method is carried out in one step, all selected reagents a) c) are mixed together and allowed to react to provide a polymer (P) as defined above.

When the method is carried out in two steps, i.e. the PFPE alcohol (A) and/or alcohol (Aa) and the PFPE sulfonic ester (B) and/or ester (Bb) are first mixed and reacted together to provide an intermediate functional polymer [“polymer (Pi)”] comprising at least one hydroxy end group or at least one sulfonic end group, which is subsequently reacted with alcohol (C) or sulfonic ester (Cc) to provide a polymer (P). When method (M) is carried out in two steps, said two steps are carried out one-pot, i.e. intermediate functional polymer (Pi) is not isolated.

Typically, method (M) is carried out by reacting a PFPE alcohol (A) and/or an alcohol (Aa) with an inorganic or organic base in order to obtain a PFPE alcohol (A) and/or alcohol (Aa) in the salified form [salified alcohol (A) or (Aa)]. Typically, this reaction is carried out in the absence of solvents and the base is used in an equivalent amount ranging from 1 to 1.5 with respect to PFPE alcohol (A) and/or alcohol (Aa). The inorganic or organic base will be selected from those skilled in the art among those whose corresponding protonated form is less acid than the PFPE alcohol (A) and/or (Aa). Examples of such bases are hydroxides, like sodium or calcium hydroxide, tertiary amines like triethylamine (TEA) and alcolates of tertiary alcohols, like potassium tert-butylate.

Salified PFPE alcohol (A) and/or salified alcohol (Aa) is then reacted with a PFPE sulfonic ester (B) and/or sulfonic ester (Bb) to provide a reaction mixture (M). Typically, the reaction is carried out by adding a solvent and a PFPE sulfonic ester (B) and/or sulfonic ester (Bb) to salified PFPE alcohol (A) and/or salified alcohol (Aa) and by heating at a temperature typically ranging from 80° C. to 130° C. The solvent is typically an aprotic solvent selected from dimethylsulfoxide (DMSO), diethylene glycol dimethyl ether (diglyme), triethylene glycol dimethyl ether (triglyme), tetraethylene glycol dimethyl ether (tetraglyme), hexafluoroxylene (HFX) and hexafluorobenzene; according to a preferred embodiment, the solvent is hexafluoroxylene (HFX). The reaction is monitored by taking samples and analysing said samples by ¹⁹F-NMR. If required, additional amounts of base are added in order to maintain suitable reaction kinetics. At the end of the reaction, the reaction mixture is cooled down to room temperature and any excess of PFPE alcohol (A) and/or alcohol (Aa) can be removed by vacuum or molecular distillation to provide a reaction residue. For cases where the equivalents of salified PFPE alcohol (A) and/or alcohol (Aa) are less than those of PFPE ester (B) and/or ester (Bb), the reaction residue is reacted with a monofunctional (per)fluoroalkyl alcohol (C); for cases where the equivalents of PFPE alcohol (A) and/or alcohol (Aa) are higher than those of PFPE ester (B) or ester (Bb), the reaction residue is reacted with a sulfonic ester (Cc).

Should method (M) be carried out in one step, monofunctional (per)fluoroalkyl alcohol (C) or sulfonic ester (Cc) are added to PFPE alcohol (A) together with the PFPE sulfonic ester (B) or ester (Bb).

Polymer (P)

Polymer (P) obtainable with the method of the invention comprises a plurality of fluorinated segments, wherein at least one fluorinated segment derives from a PFPE alcohol (A) or a PFPE sulfonic ester (B), said polymer (P) having two outermost fluorinated segments having non-functional ends.

In particular, polymer (P) obtainable with preferred methods (M-1) (M-3) is a non-functional block copolymer comprising:
a plurality of fluorinated segments [segments (S^{F})] joined together by hydrogenated (poly)ether segments [segment (S^{H})], with the proviso that segments segment (S^{H}) are not segments of formula —CH₂OCH₂OCH₂—
non-functional end groups [groups (T_{N})], deriving from an alcohol (C) or sulfonic ester (Cc) as defined above wherein at least one segment (S^{F}) is a PFPE segment and the other segments (S^{F}) are PFPE segments and/or perfluoroalkylene segments.

Polymer (P) complies with the following general formula (P):

(P)

T_{N}-(S^{F1})—(S′^{H})—(S^{F2})—[(S″^{H})—(S^{F1})—(S′^{H})—(S^{F2})]ₚ[(S′^{H})—(S_{F1})]_{q}-T_{N}

wherein:
(S^{F1}) and (S^{F2}), equal to or different from one another, are (per)fluoropolyether segments or (per)fluoroalkylene segments, with the proviso that at least one of (S^{F1}) and (S^{F2}) is a (per)fluoropolyether segment;
(S′^{H} and (S″^{H}), equal to or different from one another, are hydrogenated (poly)ether segments;
T_{N}, equal to or different from one another, is selected from:
a C₁-C₃ haloalkyl group, typically selected from —CF₃, —CF₂Cl, —CF₂CF₂Cl, —C₃F₆Cl, —CF₂Br, -CF₂CF₃ and ≤CF₂H, —CF₂CF₂H; and
a non-functional group of formula Rf2-0-Re wherein Rf2 is as defined above and Rₕ° is a straight or branched divalent alkylene segment comprising at least one carbon atom; when Rh° comprises more than one carbon atom, it can be interrupted by one or more ethereal oxygen atoms;
p is 0 or a positive number and
q is 0 or 1

with the proviso that p and q are not both 0.

Preferred polymers (P) are those wherein p is a positive number and q is equal to or higher than one. More preferably, p is a positive number, q is one and p+q is equal to or higher than 3.

In polymers (P), the at least one PFPE segment (SH) derives from the PFPE alcohol (A) or PFPE sulfonic ester (B), while perfluoroalkyl segments derive from alcohol (Aa) and/or sulfonic ester (Bb). Segments (SF) are formed by chain (R_{f}) as defined above and by any partially or fully fluorinated hydrocarbon moieties contained in group Z and Z′ of PFPE alcohol (A) or in groups E and E′ of PFPE sulfonic ester (B). For example, when a PFPE alcohol (A) of formula HOCH₂CF₂—O—R_{f}—CF₂CH₂OH or the corresponding PFPE sulfonic ester (B) is used, the at least one segments (SF) will be one of formula: —CF₂—O—R_{f}—CF₂—.

In polymers (P), segments (SH) are formed by the fully hydrogenated (polyoxy)alkylene moieties present in end groups Z and Z′ of the PFPE alcohol (A) or by the fully hydrogenated alkylene moieties in alcohol (Aa) linked via ether bond to the fully hydrogenated (polyoxy)alkylene moieties present in end groups E and E′ of a PFPE sulfonic ester (B) or to the fully hydrogenated alkylene moieties bearing the sulfonic group in sulfonic ester (Bb). For example, when a PFPE alcohol (A) of formula HOCH₂CF₂—O—R_{f}—CF₂CH₂OH or the corresponding PFPE sulfonic ester (B) is reacted with an alcohol of formula (Aa-1) or (Bb-1) as defined above wherein n*=1, segments (S^{H}) comply with formula —CH₂OCH₂—.

Segments (S′^{H}) and (S″^{H}) can be represented with formula (S^{H}—I) below:

—Rₕ—O—Rₕ′ (S^{H}—I)

wherein (Rₕ) and (Rₕ′), equal to or different from one another, are selected from straight or branched divalent alkylene segments, each comprising at least one carbon atom; when (Rₕ) and (Rₕ′) comprise more than one carbon atom, they can optionally be interrupted by one or more ethereal oxygen atoms, with the proviso that (S^{H}—I) is not a segment of formula —CH₂OCH₂OCH₂—.

Polymers (P) can thus be represented with the following general formula (P-a):

(P-a)

T_{N}-(S^{F1})—(Rₕ)O(R_{h′})—(S^{F2})—[(R_{h′})O(Rₕ)—(S^{F1)—(R}ₕ)O(R_{h′})—(S^{F2)}]ₚ—[(R_{h′})O(Rₕ)—(S′^{F1})]_{q}-T_{N}

in which (S^{F1}), (S^{F2}), (Rₕ), (Rₕ′) T_{N}, p and q are as defined above.

For the avoidance of doubt, in formula (P-a), —(Rₕ)O(Rₕ)— segments are not segments of formula —CH₂OCH₂OCH₂—.

It will be understood by a person skilled in the art that in polymers (P) in which T_{N} is a non-functional group of formula R_{f2}—O—Rₕ°, obtainable with preferred methods (M-1) (M-3), the Rₕ° group present in terminal groups T_{N} will be the same as group (Rₕ) or (Rₕ′) of the (S^{F1}) or (S^{F2}) segment which said Rₕ° group is bound to.

In preferred embodiment (M-1) as defined above, polymers (P-a) are obtained in which both (S^{F1}) and (S^{F2}) are PFPE segments, said PFPE segments being equal to or different from one another [herein after “polymers (P-a1)”], while in methods (M-2) and (M-3) as defined above, polymers (P-a) are obtained wherein one of (S^{F1}) and (S^{F2}) is a PFPE segment and the other one is a (per)fluoroalkylene segment [herein after “polymers (P-a2)]. It will be understood that, when in method (M-1) a PFPE alcohol (A) and the corresponding PFPE sulfonic ester (B) are used, (S^{F1}) and (S^{F2}) have the same structure and molecular weight and segments (S^{H}) are equal to one another. Polymers (P-a2) represent a preferred aspect of the present invention.

Preferably, (per)fluoropolyoxyalkylene chain (R_{f}) in segments (S^{F1}) and/or (S^{F2}) complies with formula (R_{f}—-I) as defined above, more preferably with formulae (R_{f}-IIA)-(R_{f}-IIE) as defined above, still more preferably with formula (R_{f}-III) as defined above.

Preferred PFPE segments (S^{F1}) and (S^{F2}) are those complying with formulae —CF₂OR_{f}CF₂— and —CF₂OR′_{f}CF₂—, wherein (R_{f}) and (R′_{f}), equal to or different from one another, comply with formula (R_{f}-III) as defined above.

Preferred (per)fluoroalkylene segments (S^{F1}) and (S^{F2}) are fully fluorinated straight alkylene chains (R_{f1a}) as defined above.

Groups (Rₕ) preferably comply with formula (Rₕ-I) below:

—CH₂(OCH₂CHY)ₙ— (Rₕ-I)

wherein, n is 0 or an integer equal to or higher than 1, preferably ranging from 1 to 10, and Y is hydrogen or methyl, preferably hydrogen. In a preferred embodiment n is 0 or 1.

Groups (Rₕ′) preferably comply with formula (Rₕ′-I) below:

—(CHY′CH₂O)_{n′}CH₂— (Rₕ′-I)

wherein Y′ is hydrogen or methyl, preferably hydrogen, and n′ is 0 or an integer equal to or higher than 1, preferably ranging from 1 to 10. In a preferred embodiment n′ is 0 or 1.

According to a preferred embodiment, in groups (Rₕ-I) and groups (Rₕ′-I), n is equal to n′ and Y is equal to Y′.

Thus, segments (S^{H}) preferably comply with formula (S^{H}-1) below (S^{H}-1) —CH₂(OCH₂CHY)ₙO(CHY′CH₂O)_{n′}CH₂—, wherein n, n′, Y and Y′, equal to or different from one another, are as defined above. According to a preferred embodiment, n is equal to n′ and Y is equal to Y′. According to another preferred embodiment, when either n or n′ is other than 0, Y and Y′ are hydrogen. According to still another preferred embodiment, n and n′ are 0.

Preferred segments (S^{H}-I) are those complying formula (S^{H}-1A) or (S^{H}-1B) below:

—CH₂OCH₂—; (S^{H}-1A)

—CH₂OCH₂CH₂OCH₂—. (S^{H}-1B)

As stated above, method (M) according to the invention allows to conveniently obtain neutral fluorinated polymers (P) comprising at least one PFPE segments, said polymers having an average number molecular weight (Mₙ) typically higher than 5,000, preferably higher than 10,000, more preferably higher than 15,000, even more preferably higher than 20,000. Such polymers (P) are endowed with high stability to harsh conditions, namely high temperature, oxidation and chemical agents and polymers (P) with an (Mₙ) higher than 15,000 are particularly useful as lubricant oils.

The invention is disclosed in greater detail in the experimental section below by means of non-limiting examples.

Should the disclosure of any patents, patent applications, and publications which are incorporated herein by reference conflict with the description of the present application to the extent that it may render a term unclear, the present description shall take precedence.

### EXPERIMENTAL SECTION

### Material and Methods

### Materials

PFPE alcohols (A) complying with formula:

ZO(CF₂CF₂O)ₐ₁(CF₂O)ₐ₂Z′

in which Z and Z′, equal to or different from one another, are selected from the groups reported in table 1 below, have been used:

TABLE 1

| | | | | | a1/ |
|---|---|---|---|---|---|
| PFPE alcohol | Z and Z′ | Mₙ | E_{w} | (F_{A}) | a2 |
| Fomblin ® Z | —CF₂CH₂OH | 2,000 | 1,000 | 2 | 2 |
| DOL (1) | | | | | |
| Fomblin ® Z | —CF₂CH₂OH | 4,000 | 2,000 | 2 | 2 |
| DOL (2) | | | | | |
| Fomblin ® Z | —CF₂CH₂OCH₂CH₂OH | 4,200 | 2,100 | 2 | 2 |
| DOL TX | | | | | |
| PFPE (3) | | | | | |
| Fomblin ® Z | —CF₂CH₂OH, | 2,000 | 1,110 | 1.8 | 2 |
| DOL (4) | CF₃—, CF₂Cl and | | | | |
| | —CF₂H | | | | |

Such PFPE alcohols are available from Solvay Specialty Polymers Italy

S.p.A. and can be prepared according to known methods.

8H,8H-dodecafluoro-1,8-octanediol was purchased from Aldrich®.

1H, 1H, 10H, 10H-hexadecafluoro-1,10-decanediol was prepared by known methods through the following steps: C₂F₄ telomerization in presence of iodine, fractionation of the telomer with desired molecular weight, insertion of ethylene and hydrolysis.

Trifluoroethanol nonaflate was prepared according to a known method, by reacting trifluoroethanol with perfluorobutansulfonyl fluoride in the presence of an excess of triethylamine as acid acceptor. The reaction was performed in hexafluoroxylene (HFX) at a temperature ranging from 0° C. to 50° C. The reaction mixture was repeatedly washed with slightly alkaline water until neutrality and afterwards with distilled water.

After phase separation, the bottom organic layer was dried over NaSO₄ and distilled in vacuum to isolate trifluoroethanol nonaflate (purity >95% and yield >90%).

### Methods

¹H-NMR analyses were performed on a Varian Mercury 300 MHz spectrometer using tetramethylsilane (TMS) as internal standard.

¹⁹F-NMR analyses were performed on a Varian Mercury 300 MHz spectrometer using CFCl₃ as internal standard.

The formation of Fomblin® Z DOL nonaflates was confirmed by ¹⁹F-NMR analysis. The typical diagnostic ¹⁹F-NMR signals of Fomblin® Z DOL nonaflates resonate at —110 ppm (C₃F₇—CF₂—SO₂), while the diagnostic signal of any perfluorobutanesulfonate resulting from hydrolysis of the nonaflate resonates at −114 ppm. The signals of the CF₂ group in the —OCF₂CH₂—O—SO₂— moiety resonate at −78 and −80 ppm, while the signals of the CF₂ in the —OCF₂CH₂OH moiety of the starting Fomblin® Z DOL PFPE (which resonate at −81 and −83 ppm) disappear once conversion is complete.

The evaluation of the conversion to polymers (P) was confirmed by the typical ¹⁹F-NMR diagnostic signals, i.e.:
CF₂ preterminal groups linked to the methylol terminal groups, which resonate at −81 ppm and −83 ppm;
CF₂ preterminal groups linked to the internal —CH₂OCH₂— sequences, which resonate at −81 ppm and −79 ppm.

Average number molecular weights (Mₙ) were determined by ¹⁹FMR; polydispersity was determined from (Mₙ) and from the weight average molar mass (M_{w}) determined by gel permeation chromatography (GPC). GPC was carried out using a Waters 5900 instrument equipped with an Ultrastyragel® set of columns (10⁵−10⁴−10³−5×10² angstroms) at 30° C., using as solvent Delifrene-LS/acetone azeotropic mixture (8/2 v/v).

The thermal and chemical stability tests on polymers (P) were carried out under isothermal conditions in ambient atmosphere and in a closed system. The polymer samples were submitted to 1H-NMR and 19F-NMR analysis at regular time intervals; this allowed to determine the decomposition percentage, the kinetic equation and t1/2, i.e. the time necessary, at a certain temperature, to decompose 50% of the product.

### EXAMPLES

Examples 1-6 illustrate method (M) comprising the use of an alcol (C) or a sulfonic ester (Cc) and carried out in two steps (referred to as steps 1 and 2 in the examples), while example 7 illustrate method (M) carried out without using an alcohol (C).

### Example 1—Synthesis of a Polymer (P) of the Invention Starting from Fomblin® Z DOL PFPE (2)

Step 1a—Synthesis of Fomblin® Z DOL PFPE (2) Nonaflate

A glass reactor was charged with triethylamine (TEA) (4.95 g, 49 meq) and perfluoro-1-butanesulfonyl fluoride (12.3 g, 40.8 meq) and the resulting mixture was kept under mechanical stirring. The internal temperature of the reaction mass was lowered to −5 /+5° C. using a dry ice bath. Fomblin® Z DOL PFPE (2) (76 g, 19 mmoles, 38 meq) was added drop-wise under vigorous stirring. After that, the reaction mixture was warmed up to room temperature, under mechanical stirring. The reaction was monitored by ¹⁹F-NMR. After 2 hours at room temperature, a sample was taken for ¹⁹F-NMR analysis (conversion 70%). The internal temperature was increased to 70° C. until completion of the reaction. After complete conversion, the reaction mixture was cooled to room temperature and washed twice with ethanol (20 g per washing). An organic bottom phase formed; this phase was separated and the solvent was stripped at 70° C. under vacuum. Fomblin® Z DOL PFPE nonaflate (Mₙ=4,560 E_{w}=2.280) was isolated with a purity >95% and a yield >90%.

Step 1—Reaction of Fomblin® Z DOL PFPE (2) with Fomblin® Z DOL PFPE nonaflate of

### Step 1 (Molar Ratio 1.1:1)

A glass reactor was charged with Fomblin® Z DOL PFPE (2) (80 g, 20 mmoles, 40 meq). The internal temperature of the resulting mixture was lowered to 10° C. using an ice bath. Anhydrous potassium tert-butoxide (2.4 g, 21 meq) was added using a tailed tube, under mechanical stirring. Thereafter, the mixture was warmed up to room temperature, under mechanical stirring, and subsequently heated to 40° C. for 3 hours and then at 80° C. under vacuum for 3 further hours, in order to remove the tert-butanol formed in the course of the reaction.

Hexafluoroxylene (HFX; 40 ml; 44% w/w vs. the formed Fomblin® Z DOL

PFPE potassium salt) was then added and the Fomblin® Z DOL PFPE nonaflate prepared in Step 1a (82 g, 18 mmoles, 36 meq) was added drop-wise under vigorous stirring in 4 hours. The resulting mixture was heated at 120° C. for 20 hrs. The progress of the reaction was followed by ¹⁹F-NMR and typically one addition of 10% by moles vs. the original amount of potassium tert-butoxide every 5 hours reaction time was necessary to maintain reasonable reaction kinetics. After complete conversion, the product was diluted with HFX/ethanol and was washed with aqueous HCl 10% w/w. The bottom organic phase was separated and washed again with basic water at 50° C. and separated. Finally, neutral water was used. Complete phase separation was carried out by centrifugation (3500 rpm, 20 min) and any residual solvents were distilled at 70° C. under vacuum.

The resulting clear product was filtered on a 0.2 μm PTFE+glass prefilter. A sample was taken and submitted to vacuum distillation at 170° C. in order to remove some volatile impurities, then analysed by ¹H-NMR, ¹⁹F-NMR and GPC. The analyses confirmed the obtainment of the following product:

HORₕ—S^{F1}—(RₕOR_{h′}—S^{F2}—R_{h′}ORₕ—S^{F1})_{p°}—RₕOR_{h′}—S^{F2}—R_{h′}ORₕ—SA^{F1}—RₕOH

wherein:

p°=2

RₕORₕ′═CH₂OCH₂

and S^{F1} and S^{F2}═CF₂O(CF₂CF₂O)ₐ₁(CF₂O)ₐ₂CF₂, with a1/a2=2

Mₙ=28,500

E_{w}=14,250

The overall yield with respect to nonaflate was 95%.

Step 2—Reaction of the product of Step 1 by reaction with the nonaflate of trifluoroethanol

50 g (1.76 mmoles, 3.53 meq) of the product obtained in Example 1, Step 1 was reacted with 1.91 g (5 mmoles) of trifluoroethanol nonaflate in the presence of 0.6 g (5.3 mmoles) of ter-ButOK. The reaction was completed after 5 h at 120° C.

The final product was isolated and the ¹⁹F and ¹H-NMR analyses confirmed the following structure:

CF₃CH₂O—SF₁—(RₕOR_{h′}—S_{F2}—R_{h′}ORₕ—S^{F1})_{p°}R_{h′}—S^{F2}—R_{h′}—ORₕ—S^{F1}—

RₕOCH₂CF₃

wherein:

p°=2

RₕORₕ′═CH₂OCH₂

and S^{F1} and S^{F2}═CF₂O(CF₂CF₂O)ₐ₁(CF₂O)ₐ₂CF₂, with a1/a2=2.

Mₙ=28,500

E_{w}=14,250

polydispersity=1.9

### Example 2—Synthesis of a Polymer (P) of the Invention Starting from Fomblin® Z DOL PFPE (1)

Step 1a—Synthesis of Fomblin® Z DOL PFPE (1) nonaflate

90 g Fomblin® Z DOL PFPE (1) nonaflate (Mₙ 2,600, E_{w} 1,300) were prepared following the procedure illustrated in Example 1, Step 1a. Purity >95%; yield >90%.

Step 1—Reaction of Fomblin® Z DOL PFPE with Fomblin® Z DOL PFPE nonaflate of Step 1a (molar ratio 1.06:1)

A glass reactor was charged with 70 g (70 meq) of Fomblin® Z DOL PFPE (1) and reacted, according to the procedure described in Example 1, Step 1, with 85.8 g (66 meq) Fomblin® Z DOL PFPE (1) nonaflate of Step 1a in a molar ratio between Fomblin® ZDOL PFPE (1)/Fomblin® ZDOL PFPE (1) nonaflate=1.06.

The analyses confirmed the obtainment of the following product:

HORₕ—S_{F1}—(RₕOR_{h′}S_{F2}—R_{h′}ORₕ—S^{F1})_{p°}—RₕOR_{h′}—S_{F2}—R_{h′}ORₕ—S_{F1}—RₕOH

wherein:

p°=3

RₕOR_{h′}═CH₂OCH₂

and S^{F1} and S^{F2}═CF₂O(CF₂CF₂O)ₐ₁(CF₂O)ₐ₂CF₂, with a1/a2=2.

Mₙ=18,300

E_{w}9,150.

The overall yield with respect to nonaflate was >95%.

Step 2—Reaction of the product of Step 1 by reaction with trifluoroethanol nonaflate

The product of Step 1 was reacted with 3.5 g (9 mmoles) of trifluoroethanol nonaflate in the presence of 1.2 g (11 mmoles) of ter-ButOK. The reaction was completed after 5 hr at 120° C.

The final product was isolated and ¹⁹F and ¹H-NMR analyses confirmed the following structure:

CF₃CH₂ORₕ—S^{F1}—(RₕOR_{h′}—S^{F2}—R_{h′}ORₕ—S^{F1})_{p°}—RₕOR_{h′}—S^{F2}—R_{h′}ORₕ—S^{F1}—

RₕOCH₂CF₃

wherein p°3

RₕOR_{h′}═CH₂OCH₂

and S^{F1} and S^{F2}═CF₂O(CF₂CF₂O)ₐ₁(CF₂O)ₐ₂CF₂, with a1/a2=2

M_{w}=18,500

E_{w}=9,250

Polydispersity=2.0

The overall yield with respect to Fomblin®ZDOL PFPE (1) nonaflate was >95%.

### Example 3—Synthesis of a polymer (P) of the Invention Comprising C6 Dodecafluoroalkylene Sequences

Step 1a—Synthesis of Fomblin° Z DOL PFPE (2) nonaflate

500 g Fomblin® Z DOL PFPE (2) nonaflate was prepared following the procedure of Example 1, Step 1a above.

Step 1—Reaction of 1H, 1H, 8H, 8H-dodecafluoro-1,8-octanediol with Fomblin® Z DOL PFPE (2) nonaflate of Step 1 a (molar ratio 1.10:1)

A glass reactor was charged with 1H, 1h, 8H, 8H-dodecafluoro-1,8-octanediol (36.2 g, 100 mmoles, 200 meq) and 80 ml hexafluoroxylene. The internal temperature of the resulting mixture was lowered to 10° C. using an ice bath. Anhydrous potassium tert-butoxide (24.1 g, 210 meq) dissolved in 300 ml of tert-butanol was added via a tailed tube, under mechanical stirring. Thereafter, the mixture was warmed up to room temperature, under mechanical stirring, and subsequently heated at 40° C. for 3 hours and then at 80° C. under vacuum for 3 further hours, in order to remove 80% of the tert-butanol present in the reaction mixture.

Fomblin® Z DOL PFPE (2) nonaflate prepared in Step la (416 g, 91 mmoles, 182 meq) was added drop-wise under vigorous stirring during 4 hours. The resulting mixture was heated at 120° C. for 20 hrs. The progress of the reaction was followed by ¹⁹F-NMR and typically one addition of 10% by moles vs. the original amount of potassium tert-butoxide every 5 hours reaction time was necessary to maintain adequate reaction kinetics.

Step 2—Reaction with Trifluoroethanol Nonaflate

After complete conversion of the Fomblin® Z DOL PFPE (2) nonaflate, the reaction mixture was added with trifluoroethanol nonaflate (11.6 g, 30 meq). After complete conversion of the residual —OH groups, the a polymer (P) was isolated.

The ¹⁹F and ¹H-NMR analyses confirmed the following structure:

CF₃CH₂ORₕ—S^{F1}—(RₕOR_{h′}—S^{F2}—R_{h′}ORₕ—S^{F1})_{p°}—RₕOR_{h′}—S^{F2}—R_{h′}ORₕ—S^{F1}—

RₕOCH₂CF³

wherein p°=2.6

S^{F1}═(CF₂)₆

S^{F2}═CF₂O(CF₂CF₂O)ₐ₁(CF₂O)ₐ₂CF₂ with a1/a2=2 and

RₕOR_{h′}═CH₂OCH₂

Mₙ=9,200

E_{w}=4,600

Polydispersity=2.05

The overall yield with respect to Fomblin® Z DOL PFPE (2) nonaflate was >95%.

### Example 4—Synthesis of a Polymer (P) According to the Invention Comprising C8 Hexadecafluoroalkylene Sequences

Step 1a—Synthesis of Fomblin® Z DOL PFPE (2) Nonaflate

This step was carried out as described in Example 1 above.

Step 1—Reaction of 1H, 1H, 10H, 10H-hexadecafluoro-1,10-decanediol with Fomblin® Z DOL PFPE(2) Nonaflate of Step 1 a (molar ratio 1.10:1)

A glass reactor was charged 1H, 1H, 10H, 10H-hexadecafluoro-1,10-decanediol (30 g, 65 mmoles, 130 meq) and 80 ml hexafluoroxylene. The internal temperature of the resulting mixture was lowered to 10° C. using an ice bath. Anhydrous potassium tert-butoxide (15.5 g, 135 meq) dissolved in 200 ml of tert-butanol was added via a tailed tube, under mechanical stirring. Thereafter, the mixture was warmed up to room temperature, under mechanical stirring, and subsequently heated to 40° C. for 3 hours and then at 80° C. under vacuum for 3 further hours, in order to remove 80% of the tert-butanol present in the reaction mixture.

Hexafluoroxylene (HFX; 40 ml; 44% w/w vs. the formed 1H, 1H, 10H, 10H-hexadecafluoro-1,10-decanediol potassium salt) was then added and the Fomblin® Z DOL PFPE (2) nonaflate prepared in Step la (269 g, 59 mmoles, 118 meq) was added drop-wise under vigorous stirring in 4 hours. The resulting mixture was heated at 120° C. for 20 hrs. The progress of the reaction was followed by ¹⁹F-NMR and typically one addition of 10% by moles vs. the original amount of potassium tert-butoxide every 5 hours reaction time was necessary to maintain adequate reaction kinetics.

Step 2—Reaction with Trifluoroethanol Nonaflate

After complete conversion of the Fomblin® Z DOL PFPE (2) nonaflate, the reaction mixture was added with trifluoroethanol nonaflate (11.6 g, 30 meq). After complete conversion of the residual OH groups, a polymer (P) was isolated, according to known methods. The ¹⁹F and ¹H-NMR analyses confirmed the following structure:

CF₃CH₂ORₕ—SF¹—(RₕOR_{h′}—S^{F2}—Rₕ—ORₕ—S^{F1})_{p°}—RₕOR_{h′}—S^{F2}—R_{h′}ORₕ—S^{F1}—

RₕOCH₂CF³

wherein p°=2.6

S^{F1}=(CF₂)₈

S^{F2}=CF₂O(CF₂CF₂O)ₐ₁(CF₂O)ₐ₂CF₂ with a1/a2=2 and

RₕOR_{h′}=CH₂OCH₂

Mₙ=9,700

E_{w}=4,350

Polydispersity=2.05

The overall yield with respect to Fomblin® Z DOL PFPE was higher than 95%.

### Example 5—Synthesis of a Polymer (P) According to the Invention Starting from Fomblin® Z DOL PFPE (2) and Fomblin® Z DOL TX PFPE (3)

### Step 1a —Synthesis of Fomblin° Z DOL PFPE (2) Nonaflate

100 g (44 meq) of Fomblin® Z DOL PFPE (2) nonaflate were prepared according to the procedure described in Example 1, Step 1a, with a purity >95% and a yield >90%.

Step 1—Reaction of Fomblin® Z DOL TX PFPE (3) with Fomblin® Z DOL PFPE (2) Nonaflate of Step 1 a (Molar Ratio 1.1:1)

The same reaction as described in Step 1 of Example 1 was carried out with the sole difference that Fomblin® ZDOLTX PFPE (3) 80 g (38 meq) was used and the molar ratio between Fomblin® ZDOLTX PFPE (3) and Fomblin® ZDOL PFPE nonaflate was 1.1.

Step 2—Reaction with Trifluoroethanol Nonaflate

After complete conversion, the reaction mixture from Step 1 was reacted with 3.9 g (10 mmoles) trifluoroethanol nonaflate in the presence of 0.9 g (8 mmoles) ter-ButOK. The reaction was completed after 5 h at 120° C.

The final product was isolated and the ¹⁹F and ¹H-NMR analyses confirmed the following structure:

CF₃CH₂ORₕ—S^{F1}—(RₕOR_{h′}—S^{F2}—Rₕ—ORₕ—S^{F1})_{p°}—RₕOR_{h′}—S^{F2}—R_{h′}ORₕ—S^{F1}—

RₕOCH₂CF³

wherein:

p°=2.2

RₕORₕ′═CH₂OCH₂CH₂OCH₂

S^{F1}═CF₂O(CF₂CF₂O)ₐ₁(CF₂O)ₐ₂CF₂with a1/a2=2 from Fomblin® Z DOL TX PFPE (3)

S^{F2}═CF₂O(CF₂CF₂O)ₐ₁(CF₂O)ₐ₂CF₂with a1/a2=2 Fomblin® Z DOL PFPE (2) nonaflate

Mₙ=30,100

E_{w}15,050

Polydispersity=1.9

### Example 6—Synthesis of a Polymer (P) According to the Invention from Fomblin® Z DOL PFPE (1)

Step 1a—Synthesis of Fomblin° Z DOL PFPE (1) Nonaflate

100 g Fomblin® Z DOL PFPE (1) nonaflate (Mₙ 2,600, E_{w} 1,300, meq 77) were prepared following the same procedure as disclosed in Example 1, Step 1a.

Purity >95%; yield >90%.

Step 1—Reaction of Fomblin® Z DOL PFPE with Fomblin° Z DOL PFPE Nonaflate of Step 1 a (Fomblin® ZDOL PFPE (1)/Fomblin® ZDOL PFPE (1) Nonaflate=0.9)

A glass reactor was charged with 62 g (62 meq) Fomblin® Z DOL PFPE (1) and reacted, according to the procedure described in Example 1, Step 1, with 90g (69 meq) Fomblin® Z DOL PFPE (1) nonaflate of Step 1a in a molar ratio between Fomblin® ZDOL PFPE (1)/ Fomblin® ZDOL PFPE (1) nonaflate=0.9.

Step 2—Reaction with Trifluoroethanol

After complete conversion, the reaction mixture was added with 1.5 g (15 mmoles) of trifluoroethanol in the presence of 1.2 g (11 mmoles) of ter-ButOK. The reaction was completed after 5 h at 120° C.

The final product was isolated and the ¹⁹F and ¹H-NMR analyses confirmed the obtainment of the following product:

The analyses confirmed the obtainment of the following product:

CF₃CH₂ORₕ—S^{F1}—(RₕOR_{h′}—S^{F2}—Rₕ—ORₕ—S^{F1})_{p°}—RₕOR_{h′}—S^{F2}—R_{h′}ORₕ—S^{F1}—

RₕOCH₂CF₃

wherein:

p°=3

RₕOR_{h′}═CH₂OCH₂

and S_{F1} and S^{F2}′CF₂O(CF₂CF₂O)ₐ₁(CF₂O)ₐ₂CF₂, with a1/a2=2

Mₙ=18,100

E_{w}=9,200

Polydispersity=1.8

The overall yield with respect to Fomblin®ZDOL PFPE (1) nonaflate was >95%.

### Example 7—Synthesis of a Polymer (P) from Fomblin® Z DOL PFPE (4) Nonaflate and Fomblin® Z DOL PFPE (1)

Step 1a—Synthesis of Fomblin® Z DOL PFPE (4) Nonaflate

100 g Fomblin® Z DOL PFPE (4) nonaflate (Mₙ2,500, E_{w} 1,390, meq 72) were prepared following the same procedure as disclosed in Example 1, Step 1a.

Purity >95%; yield >90%.

Step 1—Reaction of Fomblin® Z DOL PFPE (1) with Fomblin® Z DOL PFPE (4) Nonaflate of Step 1a (Molar Ratio 1:1)

A glass reactor was charged with 62 g (62meq) of Fomblin® Z DOL PFPE (1) and reacted, according to the procedure described in Example 1, Step 1, with 86.2g (62 meq) Fomblin® Z DOL PFPE (4) nonaflate of Step 1a in a molar ratio between Fomblin® ZDOL PFPE (1)/ Fomblin®ZDOL PFPE nonaflate=1.

The final product was isolated and the ¹⁹F and ¹H-NMR analyses confirmed the obtainment of the following product:

T_{N}-S^{F1}—(RₕOR_{h′}—S^{F2}—R_{h′}ORₕ—S^{F1})_{p°}—RₕOR_{h′}—S^{F2}—R_{h′}ORₕ—S^{F1}-T_{N}

wherein: p°=2

RₕOR_{h′}═CH₂OCH₂

and S^{F1} and S^{F2}═CF₂O(CF₂CF₂O)ₐ₁(CF₂O)ₐ₂CF₂, with a1/a2=2

T_{N} are neutral terminal groups of formula CF_{3—}, —CF₂Cl and CF₂H

Mₙ=14,000

E_{w}=7,000

Polydispersity=1.85

The overall yield with respect to)/Fomblin®ZDOL PFPE nonaflate was >95%.

### Evaluation of the Thermal-Oxidative Stability

The stability of the polymer obtained in Example 1 to temperature and oxidation was evaluated and a kinetic equation for the decomposition was obtained. The half-time as a function of temperature is reported in the table below:

TABLE 2

| Temperature (° C.) | t½ (h) |
|---|---|
| 250 | 870 |
| 270 | 350 |
| 290 | 150 |

### Thermo-Chemical Stability Test

The product polymer obtained in Example 1 was evaluated under thermo-chemical conditions and a kinetic equation for the decomposition was obtained. The half-time as a function of temperature is reported in the table below:

TABLE 3

| | | Base vs. mole | | |
|---|---|---|---|---|
| Temperature (° C.) | Base | of product (%) | solvent | t½ (h) |
| 180 | t-BuOK | 5 | neat | 37000 |
| 180 | K₂CO₃ | 500 | neat | 37000 |
| 180 | t-BuOK | 5 | DMSO | 36000 |
| 180 | t-BuOK | 100 | DMSO | 30000 |

1. A method for the manufacture of a fluorinated polymer (P), said method comprising the reaction of:
a) a first reagent (R1), wherein reagent (R1) is an alcohol selected from:
a PFPE alcohol (A) wherein PFPE alcohol (A) is a (per)fluoropolyether alcohol having an average functionality (F_{A}) ranging from 1.2 to 2,
an alcohol (Aa) wherein alcohol (Aa) is a fluoroalkylene diol, and
mixtures thereof;
b) a second reagent (R2), wherein reagent (R2) is a sulfonic ester selected from:
a PFPE sulfonic ester (B), wherein PFPE sulfonic ester (B) is a sulfonic ester of a PFPE alcohol having an average functionality (F_{B}) ranging from 1.2 to 2,
a sulfonic ester (Bb), wherein sulfonic ester (Bb) is a sulfonic diester of a fluoroalkylene diol, and
mixtures thereof; and
c) a third reagent (R3), wherein reagent (R3) is:
an alcohol (C), wherein alcohol (C) is a mono-functional (per)haloalkyl alcohol, or
a sulfonic ester (Cc), wherein sulfonic ester (Cc) is a sulfonic ester of alcohol (C), reagent (R3) being optional when (F_{A}) and/or (F_{B}) is lower than 1.98,
in the presence of an organic or inorganic base,
wherein:
(i) at least reagent (R1) is a PFPE alcohol (A) or at least reagent (R2) is a PFPE sulfonic ester (B) and in that:
(iia) when reagent (R3) is not used, the overall equivalents of alcohols are the same as the overall equivalents of sulfonic esters; and
(iib) when reagent (R3) is used, the overall equivalents of alcohols are the same as the overall equivalents of sulfonic esters or reagent (R3) can be used in excess with respect to the amount required to comply with this proviso.

2. The method according to claim 1 wherein reagent (R1) is a PFPE alcohol (A) and reagent (R2) is a PFPE sulfonic ester (B).

3. The method according to claim 1 wherein reagent (R1) is a PFPE alcohol (A) and reagent (R2) is a sulfonic ester (Bb).

4. The method according to claim 1 wherein reagent (R1) is an alcohol (Aa) and reagent (R2) is a PFPE sulfonic ester (B).

5. The method according to claim 1 wherein at least one of (F_{A}) or (F_{B}) is higher than 1.80.

6. The method according to claim 1 wherein PFPE alcohol (A) complies with formula (A 1):
Z—O—R_{f}—Z′ (A-1)
wherein (R_{f}) is a fluoropolyoxyalkylene chain and Z and Z′, equal to or different from one another, represent a hydrocarbon group containing one hydroxy group, said hydrocarbon group being partially fluorinated and optionally containing one or more ethereal oxygen atoms, or a C₁-C₃ haloalkyl group.

7. The method according to claim 6 wherein groups Z and Z′ comply with formula (Z-1):
—CFX°CH₂(OCH₂CHY)ₙOH (Z-1)
wherein:
X° is F— or CF₃—,
Y is hydrogen or methyl and
n is 0 or an integer equal to or higher than 1.

8. The method according to claim 1, wherein PFPE sulfonic ester (B) complies with formula (B-1):
E-O-R_{f}-E′ (B-1)
wherein (R_{f}) is a fluoropolyoxyalkylene chain and E and E′, equal to or different from one another, represent a hydrocarbon group bearing one sulfonic ester group, said hydrocarbon group being partially fluorinated and optionally containing one or more ethereal oxygen atoms, or a C₁-C₃ haloalkyl group.

9. The method according to claim 8, wherein groups E and E′ comply with formula (E-1):
—CFX°CH₂(OCH₂CHY)ₙE* (E-1)
wherein:
X° is F— or CF₃—,
Y is hydrogen or methyl,
n is 0 or is an integer equal to or higher than 1, and
E^{*} is selected from a mesylate, nonaflate or tosylate group.

10. The method according to claim 8, wherein chain (R_{f}) complies with formula (R_{f}-III) here below:
—(CF₂CF₂O)ₐ₁(CF₂O)ₐ₂— (R_{f}-III)
wherein:
a1, and a2 are integers >0 such that the number average molecular weight is between 400 and 4,000, with the ratio a2/a1 being comprised between 0.2 and 5.

11. The method according to claim 1, wherein alcohol (Aa) complies with formula (Aa-1):
HO—(CH₂)_{n*}—(R_{f1a})—(CH₂)_{n*}—OH (Aa-1)
wherein:
(R_{f1a}) is a straight or branched fully or partially fluorinated alkylene chain and
n* is 1 or 2.

12. The method according to claim 1, wherein sulfonic ester (Bb) complies with formula (Bb 1):
R—SO₂O—(CH₂)_{n*}—(R_{f1a})—(CH₂)_{n*}—OSO₂R
wherein:
(R_{f1a}) is a straight or branched fully or partially fluorinated alkylene chain;
n* is 1 or 2; and
R is selected from: (halo)alkyl and aryl, wherein the aryl moiety optionally bears one or more (halo)alkyl substituents and/or one or more nitro groups.

13. The method according to claim 1, wherein reagent (R3) is used and wherein reagent (R3) is an alcohol (C) or a sulfonic ester (Cc) respectively complying with formulae (C-1) or and (Cc-1):
R_{f2}—OH (C-1)
R_{f2}—OSO₂R (Cc-1)
wherein:
(R_{f2}) is a straight or branched fully or partially halogenated alkyl chain, said chain optionally comprising one or more ethereal oxygen atoms and
R is selected from: (halo)alkyl and aryl, wherein the aryl moiety optionally bears one or more (halo)alkyl substituents and/or one or more nitro groups.

14. The method according to claim 1 wherein reagent (R3) is used and:
either all reagents are mixed together and reacted to provide polymer (P) or
PFPE alcohol (A) and/or alcohol (Aa) and PFPE ester (Bb) and/or ester (Bb) are first reacted together to provide an intermediate functional polymer (Pi) comprising at least one hydroxy end group or at least one sulfonic end group, which is reacted, without being isolated, with alcohol (C) or sulfonic ester (Cc).

15. A polymer complying with formula (P-a):
(P-a)
T_{N}-(S^{F1})—(Rₕ)O(R_{h′})—(S^{F2})—[(R_{h′})O(Rₕ)—(S^{F1})—(Rₕ)O(R_{h′})—(S^{F2)}]ₚ—[(R_{h′})O(Rₕ)—(S′^{F1})]_{q}-T_{N}
in which:
one of (S^{F1}) or (S^{F2}) is a (per)fluoropolyether segment and the other one is a (per)fluoroalkylene segment;
(Rₕ) and (R_{h′}) equal to or different from one another, are selected from straight or branched divalent alkylene segments, each comprising at least one carbon atom; when (Rₕ) and (R_{h′}) comprise more than one carbon atom, they can optionally be interrupted by one or more ethereal oxygen atoms
each T_{N}, equal to or different from one another, is selected from:
a C₁-C₃ haloalkyl group, typically selected from —CF₃, —CF₂Cl, —CF₂CF₂Cl, —C₃F₆Cl, —CF₂Br, —CF₂CF₃ and —CF₂H, —CF₂CF₂H; and
a non-functional group of formula R_{f2}—O—Rₕ° wherein R_{f2} is as defined above and Rₕ° is a straight or branched divalent alkylene segment comprising at least one carbon atom; when Rₕ° comprises more than one carbon atom, it can be interrupted by one or more ethereal oxygen atoms;
p is 0 or a positive number and
q is 0 or 1
with the proviso that p and q are not both 0.

16. The method according to claim 6, wherein the C₁-C₃ haloalkyl group is selected from —CF₃, —CF₂Cl, —CF₂CF₂Cl, —C₃F₆Cl, —CF₂Br, —CF₂CF₃, —CF₂H, and —CF₂CF₂H.

17. The method according to claim 8, wherein the C₁-C₃ haloalkyl group is selected from —CF₃, —CF₂Cl, —CF₂CF₂Cl, —C₃F₆Cl, —CF₂Br, —CF₂CF₃, —CF₂H, and —CF₂CF₂H.
